(19) United States
(12) Patent Application Publication
(10) Pub. No.: US 2010/0318469 A1
(43) Pub. Date: Dec. 16, 2010

(54) MANAGEMENT OF CLAIMS

(75) Inventors: Anthony Mark Burbage, Vancouver (CA); Michal Ralek, Richmond (CA); Liezel S. Lorico, Vancouver (CA); Joanna Plumpton, Montreal (CA); Remick Selvon Tadesse-Lee, Vancouver (CA)

Correspondence Address: KNOBBE MARTENS OLSON & BEAR LLP, 2040 MAIN STREET, FOURTEENTH FLOOR, IRVINE, CA, 92614, US

(73) Assignee: Navarik Corp., Vancouver (CA)

(21) Appl. No.: 12/813,325

(22) Filed: Jun. 10, 2010

Related U.S. Application Data
(60) Provisional application No. 61/185,880, filed on Jun. 10, 2009.

(51) Int. Cl. G06Q 10/00; G06Q 30/00

(52) U.S. Cl. 705/80

(57) ABSTRACT

A claim management system tracks negotiations between parties as part of settlement of a claim. The claim management system generates one or more user interfaces for use by parties associated with the claim. A user interface may include a status indicator, claim information, and a history of offers made. Depending on the status of the claim, the claim management system generates a user interface with an acceptance control for selection by a party to accept an offer made to settle the claim between the parties. Upon selection of the acceptance control, the claim management system automatically updates the status indicator for the parties associated with the claim and automatically notifies the parties associated with the claim.

### CROSS-REFERENCE TO RELATED APPLICATIONS

This utility patent application claims the benefit under 35 U.S.C. §119(e) of U.S. Provisional Patent Application 61/185,880, entitled System and Method for Negotiating and Resolving Marine-related Claims filed on Jun. 10, 2009, which is hereby incorporated by reference in its entirety.

### BACKGROUND

Chartering is a common activity in the shipping industry, wherein a vessel or ship is hired or chartered for transport. There are generally four different types of charters: a voyage charter, a time charter, a demise charter, and a bareboat charter.

A voyage charter is the hiring of a vessel and crew for a voyage between a load port and a discharge port. The charterer pays the ship owner either on a per-ton, called the freight rate, or a lump-sum basis for the agreed duration of the charter.

A time charter is the hiring of a vessel for a specific period of time. In this type of charter, the charterer determines which ports the vessel will call and directs the voyage. The ship owner is still responsible for the management and administration of the vessel and the crew.

A demise charter is the hiring of a vessel for a long period, usually years, and the charterer takes full legal and financial responsibility for the vessel. The crew remains the ship owner's responsibility.

A bareboat charter is much like the demise charter with the additional ability for the charterer to appoint their own master and crew.

The chartering process begins with the sale of a cargo and identifying a vessel to transport the cargo. Contracts for the sale of the cargo and for the hiring of the vessel are negotiated and agreed upon by the parties involved. The contract between a ship owner and the charterer that details the terms, conditions, and exceptions for hiring the ship is called a charter party. A charter party may be made between other parties besides the ship owner and the charterer. For example, a shipbroker may enter into a charter party with the charterer.

For a voyage charter, the charter party outlines the freight due, either per ton or lump sum, for the conveyance of the cargo from the load port to the discharge port. The charter party also outlines the time allowed at each port for the loading and discharge of the cargo, as well as the events that would not be included in determining the duration in which the ship is at the port.

The limited time period allowed for loading and discharging the cargo is called laytime, and is usually specified in hours. Typically, the ship charterer estimates the time required for loading and discharging the cargo at each port, and negotiates the laytime with the cargo seller, cargo buyer, and ship owner. The charter party may define the cumulative time allowed for both the load and discharge operations, while individual cargo sales contracts may define the laytime at the respective ports.

As an example, and not to be construed as limiting, the charter party may state that the ship charterer is allowed a laytime of 72 hours. The cargo sale contract between the ship charterer and the cargo seller at the load port may say the laytime for loading the cargo is 36 hours, and the contract between the ship charterer and the cargo buyer at the discharge port may also say the laytime for discharging the cargo is 36 hours.

If the ship charterer exceeds the overall laytime of 72 hours for loading and discharging the cargo on this voyage, it is in breach of the charter party and, hence, is liable to pay damages to compensate the ship owner for that breach. In this case, the total liquidated damages are referred to as demurrage. Additionally, if the cargo seller exceeds the laytime of 36 hours at the load port, it is liable to pay demurrage to the ship charterer.

Conversely, if the ship charterer took less time than the laytime defined in the charter party for loading and/or discharging, the ship owner would pay the ship charterer. The compensation paid by the ship owner to the ship charterer is referred to as despatch.

The demurrage is calculated using the demurrage rate that is usually stated in the charter party. In this example, both the ship owner and charterer agreed in advance to the demurrage rate. Similarly, despatch can also be calculated using a rate provided in the charter party. The rates for demurrage and despatch are usually defined as an amount per day.

With further reference to the above example, the ship charterer exceeded the contractually allowed laytime by 4 hours, and a demurrage rate stated in the charter party is $100,000 per day. The ship owner calculates the demurrage they are owed by the charterer to be $16,667 [calculated as (75,000 dollars per day 124 hours per day)*4 hours].

Additionally, if the ship charterer determines the cargo seller exceeded laytime by 2 hours, the ship charterer may also submit a claim to the cargo seller for the demurrage owed them.

In some embodiments, the claim must be submitted within a predetermined number of days from the date on the cargo's bill of lading. This period, referred to as a time bar, is also defined in the charter party and the sales contract. If the ship owner or ship charterer fails to submit the claim within the time bar, then they may forfeit their right to submit a claim to the other party.

To determine the time it took for the loading and discharge operations at the respective ports, the ship owner, ship charterer, and cargo owners individually calculate the duration based on time logs recorded by the ship master, the port agent appointed by the charterer, the personnel at the terminal where the vessel is docked, and the cargo inspectors hired by the cargo owners. These parties record the time when the activities occurred at the port during the load or discharge operation. Examples of these activities are notice of readiness tendered, hoses connected, commence loading, finish loading, and hoses disconnected. Using the times recorded in these time logs, the ship owner, ship charterer, and cargo owners may calculate how much time it took for the load and/or discharge operations. This process may be referred to as laytime calculation.

The ship owner, ship charterer, and cargo owners also take into consideration the exceptions stated in the charter party or the cargo sale contract, such as delay due to bad weather, since these exceptions determine if the duration for these exceptions should be included in the laytime calculation or not. They also examine reports from the cargo inspectors, port authorities, and other parties involved in the load or discharge operations.

Since there are numerous sources of information for calculating the duration of the load and discharge operations, the different parties generally end up with different demurrage or despatch amounts owed. For example, a ship owner may calculate that the ship charterer exceeded the laytime by 15 hours, but the ship charterer may calculate that they exceeded the laytime by only 1 hour. If the demurrage rate is $100,000 per day, this 14-hour difference amounts to over $58,000. Thus, disputes regarding the amount owed between parties occurs frequently, and the amount in question may be substantial.

When two parties are in disagreement about the demurrage or despatch owed, they may then engage in negotiations over the claimed amount. Each party may propose their own claim amounts based on their respective calculations and analysis. The negotiations continue until the two parties eventually come to an agreement about the demurrage or despatch owed. In cases where the two parties cannot reach an agreement, they may opt to proceed with litigation or arbitration.

Currently, claim negotiations may be conducted via mail or e-mail, and are often conducted by negotiators acting on behalf of the parties involved in the claim. However, conducting negotiations via mail or email may each contain its own set of unique problems. For example, the letters sent via mail may take a large amount of time to be delivered, or may be lost. As such, conducting negotiations via mail generally requires additional steps such as calling to ensure a letter was received, keeping track of the various paper documents, and the like.

Conducting claim negotiations via e-mail may also prove difficult. In the case where a negotiator is negotiating the claim on behalf of a party, all of the information related to the negotiation may be stored by the negotiator. In the case where the negotiator is unavailable or a new negotiator is to be used, all the information regarding the negotiations is transmitted to the new negotiator. In such an instance, a great amount of time may be spent attempting to recreate the negotiations. Furthermore, not all of the documents may be stored or transferred correctly. In addition storing the information in this way may make it difficult to share information with third parties who were involved in the cargo movement or ship charter.

### BRIEF DESCRIPTION OF THE DRAWINGS

FIG. 1 is a block diagram illustrative of a claim management environment including a number of client computing devices and a claim management system.

FIG. 2 is a block diagram illustrative of an expanded view of a data storage device associated with the claim management system of FIG. 1.

FIGS. 3A-3C are state diagrams illustrative of the interaction between the various components of the claim management environment of FIG. 1.

FIGS. 4A-4B are state diagrams illustrative of an alternative embodiment of the interaction between the various components of the claim management environment of FIG. 1.

FIG. 5 is a flow diagram illustrative of one embodiment of a routine implemented by the claim management system for automatically updating a status indicator and notifying parties that an offer to settle a claim has been accepted.

FIG. 6A is an illustrative user interface reflecting a status of claim negotiations before an acceptance control is selected.

FIG. 6B is an illustrative user interface reflecting a status of claim negotiations after an acceptance control is selected.

FIG. 7 is an illustrative user interface reflecting a status of claim negotiations being conducted by a third party negotiator.

### DETAILED DESCRIPTION

Generally described, the present disclosure is directed to a system, method, and computer-readable non-transitory storage medium for managing claim negotiation processes and associated data. Specifically, aspects of the disclosure will be described with regard to receiving negotiation information and offers made and automatically notifying parties upon receipt of an acceptance of an offer made. Although various aspects of the disclosure will be described with regard to examples and embodiments, one skilled in the art will appreciate that the disclosed embodiments and examples should not be construed as limiting.

As used herein a legal entity may be any corporate, business, or institutional entity, person, or individual represented in the claim management system that will be described in greater detail below. In one embodiment, a legal entity may be any organization that is legally permitted to enter into a contract and be held liable if it fails to meet its contractual obligations. As used herein, a creator is a legal entity that creates or initiates a claim in the claim management system. As used herein, an issuer is a legal entity making a claim against another legal entity. As used herein, a receiver is a legal entity against which a claim is made. As used herein, a negotiator is a legal entity representing a receiver or an issuer to negotiate settlement of a claim. A negotiator may also be referred to as a negotiating party. As used herein, an observer is a legal entity granted access by the creator, issuer and/or receiver to at least view a claim in the claim management system. In one embodiment, the observer may only view a claim. In another embodiment, the observer may have greater access granted, or be enabled to perform additional operations, as will be described in greater detail below.

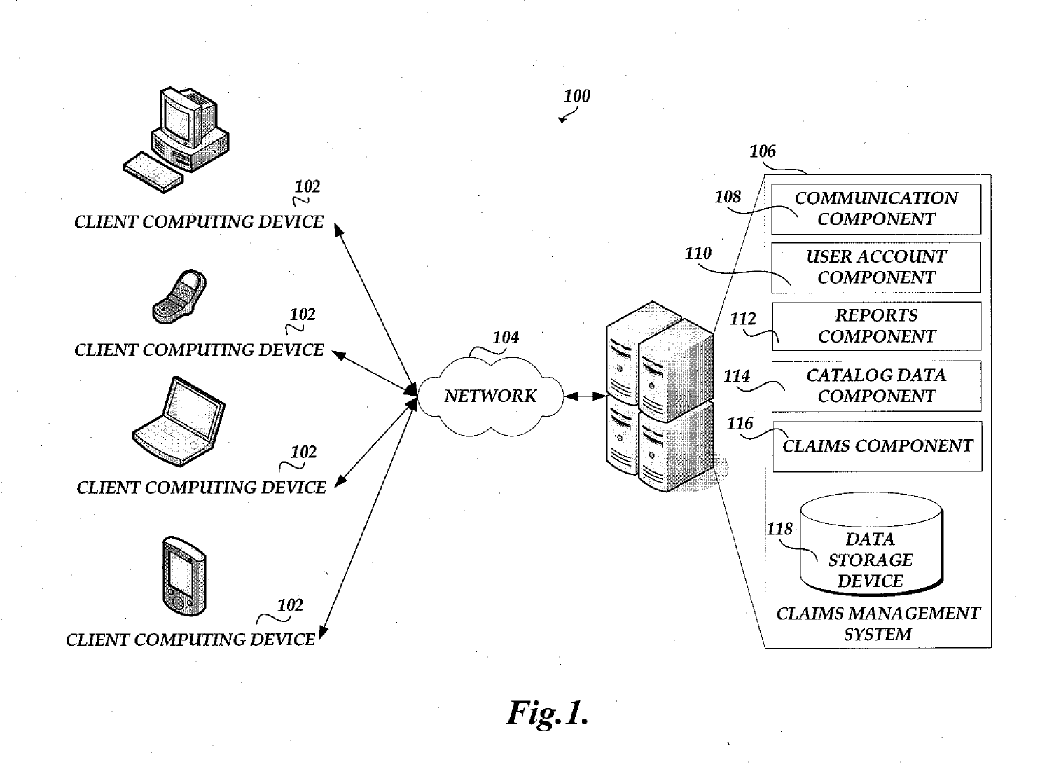

FIG. 1 is a block diagram illustrative of a claim management environment 100 for the management of claim negotiations between parties regarding a contract. As illustrated in FIG. 1, the claim management environment 100 includes a number of client computing devices 102 in communication with a claim management system 106 via a communication network 104. As illustrated in FIG. 1, the client computing devices 102, claim management system 106, and communication network 104 may each be different devices.

With further reference to FIG. 1, the client computing devices 102 (also generally referred to as clients) create and submit claims to the claim management system 106 via the communication network 104. The client computing devices 102 may then be utilized to negotiate the claims using the claim management system 106. In an illustrative embodiment, the client computing devices 102 can correspond to a wide variety of computing devices including personal computing devices, laptop computing devices, hand-held computing devices, terminal computing devices, mobile devices, wireless devices, various electronic devices, appliances and the like. In an illustrative embodiment, the client computing devices 102 include necessary hardware and software components for establishing communication over the communication network 104. For example, the client computing devices 102 may be equipped with networking equipment and browser software applications that facilitate communication via the communication network 104. Although not illustrated in FIG. 1, each client computing device 102, may also display a user interface. The user interface may include various menus and fields for entering and displaying claim data and negotiation data. The user interface may further present the results of any processing performed by the claim management system 106 in an easy to understand format.

With continued reference to FIG. 1, the communication network 104 may comprise any number of different networks including a wide area network, local area network, a satellite network, a cable network, a personal area network, or the like. The network may be a wireless network, wired network, or a combination thereof. In one embodiment, the communication network 104 may be the Internet or an intranet.

With still further reference to FIG. 1, the claim management system 106 illustrated in FIG. 1 may correspond to a logical association of one or more computing devices associated with a claim management system 106. Specifically, in an illustrative embodiment, the claim management system 106 can include a communication component 108, a user account component 110, a reports component 112, a catalog data component 114, a claims component 116, and a storage component 118.

One skilled in the relevant art will appreciate that the claim management system 106 can be associated with various additional computing resources, such as access components, time log components, invoice components, administrative components, servers, and the like. For example, although not illustrated, claim management system 106 can be associated with one or more authentication components, located either locally or remotely, for authenticating a client computing device 102 before the client computing device 102 is allowed access to the features of the claim management system 106.

The communication component 108 may be used to send and receive claim data and negotiation data to the client computing devices 102. The interface component 108 may be configured to communicate with the client computing device 102 via the communication network 104. The interface component 108 may also be capable of translating the data received via the communication network 104 into a format understandable by the claim management system 106 and vice versa.

The user account component 110 may be generally used to track the accounts of various parties that use the claim management system 106. In one embodiment, the user account component 110 is configured to create, update, delete, generate a user interface for, and search for user accounts in the claim management system 106. In one embodiment, the user account component 110 may further be configured to ensure only authorized users are able to login to the claim management system 106. The user account component 110 may further track the levels of access each party may have with regards to a particular claim or negotiation data associated with the claim. For instance, one party may have access to create, submit, and otherwise modify a claim within the claim management system 106. The party may further have access to negotiate a claim and/or accept an offer made related to the claim. Another party may only have access to view an already submitted claim and the negotiations related to the claim.

The reports component 112 may be used generate reports relating to various claims and the negotiations of those claims. The generated reports may further include information relating to use of the claim management system 106, account status, and the like. The generated reports may be stored in the data storage device 118 or be transmitted to the client computing device 102.

The claims component 116 may be used to process claims that are submitted by the client computing device 102. The claims component may further generate a user interface for the client computing device 102 to be used by a party to enter claim data, create and submit claims, submit communications with respect to the claims, upload documents related to the claims, make offers with respect to the claims, accept offers made with respect to the claims, and otherwise negotiate the claims. The claims component 116 may further store the claim data and negotiation data in the data storage device 118.

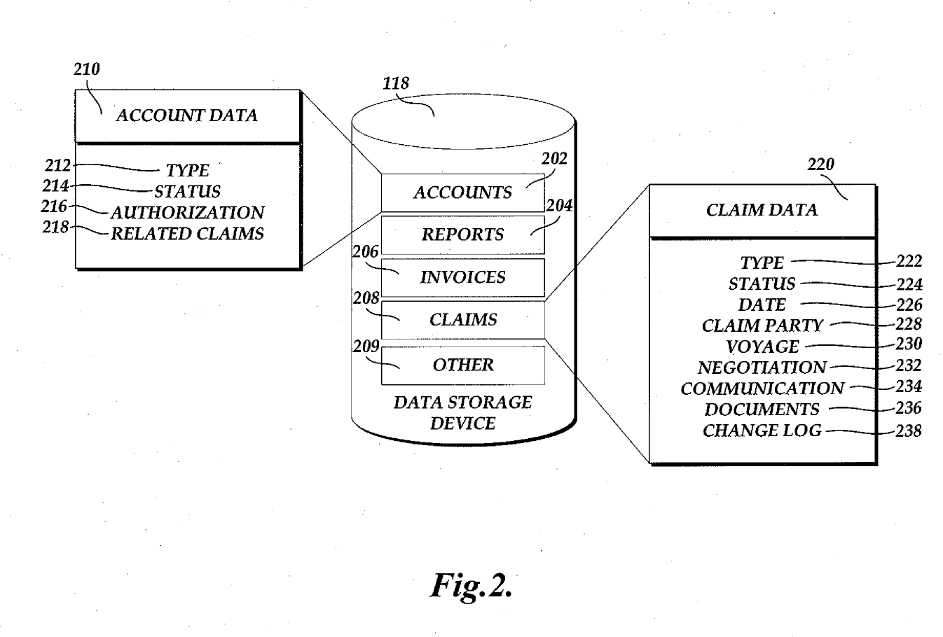

The data storage device 118 may be used to store accounts 202, reports 204, invoices 206, claims 208, other data 209, and the like. The information stored on data storage device 118 will be described in further detail below in reference to FIG. 2. The data storage device 118 may reside locally on the same device as the claim management system 106 or it may be located remotely and communicate with the claim management system 106 via the communication network 104. Furthermore, the data storage device 118 may comprise one or many data storage devices, each device containing the same or different data.

One skilled in the relevant art will also appreciate that the components and configurations provided in FIG. 1 are illustrative in nature. Accordingly, additional or alternative components and/or configurations, especially regarding the additional components, systems, and subsystems for facilitating communication may be utilized. Additionally, the various components associated with the claim management system 106 may be located within a single device, or may be distributed among a number of different devices. When distributed among a number of devices, the different devices may communicate via the communication network 104. In one embodiment, the claim management system 106 and client computing device 102 may be located within a single device. In this, or any other embodiment, the data storage device 118 may be located locally or remotely. Thus, the claim management environment 100 may be arranged in any number of configurations without departing from the spirit or scope of the present description.

Turning now to FIG. 2, an illustrative embodiment of the data storage device 118 is provided. As similarly set forth above, the data storage device 118 may reside locally on the same device as the claim management system 106 or it may be located remotely and communicate with the claim management system 106 via the communication network 104. Furthermore, the data storage device 118 may comprise one or many data storage devices, each device containing the same or different data. The data storage device 118 may store, for example, accounts 202, including account data 210, reports 204, invoices 206, claims 208, including claim data 220, other data 209, and the like.

The accounts 202 may comprise a number of different accounts associated with various parties that use the claim management system 106. Each account may be associated with account data 210. The account data 210 may comprise type data 212 status data 214, authorization data 216, related claims data 218, and the like.

The type data 212 may indicate an account type with respect to a particular claim. As will be described in greater detail below an account may be identified as a creator, issuer, receiver, and/or negotiator for a particular claim. Additional types of account are envisioned with various levels of access granted without departing from the spirit and scope of the disclosure.

The status data 214 may indicate the status of the account. The status may comprise one of many different types. For example, the status may reflect use information, payment information and the like. For instance, an account may be considered past due, paid in full, and the like. In addition the account status may reflect limited use, current use, or abandoned, depending on the amount of use the account receives. The status data 214 may also indicate whether an account has been disabled.

The authorization data 216 may indicate the authorization of the account for various claims, or indicate the actions a party is allowed to perform. For instance, for some claims the account may be authorized to create, submit and/or modify the claims. The account may be further authorized to upload documents and notes, submit counteroffers, accept offers made, or otherwise negotiate the claim. For other claims, the account may only be authorized to view the status of the claim. For yet other claims, the account may be authorized to view the claim, the negotiations history and the like. This data may be stored as authorization data 216. Additional levels and types of authorization are envisioned without departing from the spirit and scope of the disclosure.

The related claims data 218 may indicate the claims to which the account has some level of authorization, or are somehow related. For instance, the related claims data 218 may contain a listing of the claims to which the account has authorization to view, modify, and/or negotiate. In one embodiment, the related claims data 218 may further comprise a list of all claims submitted using the account, all claims where the account holder is listed as a party (e.g., receiver, issuer, negotiator, observer, etc.), and the like.

The reports 204 may comprise information relating to a particular claim or voyage related to the claim formatted to be easily understood by a user. In one embodiment, the report 204 may simply include a summary of claim data 220 to facilitate comprehension. Furthermore, the reports 204 may include a summary of account data 210 for one or more accounts, a summary of claim data 220 for one or more claims, a summary of invoices 206, and the like. Furthermore, the reports 204 may include historical information regarding account use, claims submitted, claims agreed to, offer amounts, and the like. The reports 204 may additionally contain information to diagnosis problem areas, and aid in developing strategies to reduce demurrage or despatch fees.

The invoices 206 contain accounting information. The invoices 206 may relate to companies using the claim management system 106 and contain information on system use and amounts owed. The invoices 206 may further indicate past due amounts, credits, historical indications, trends, and the like.

With further reference to FIG. 2, an expanded view of one embodiment of the claim data 220 is illustrated. The claim data 220 is used by the claim management system 106 to track the status and negotiation history of a claim. The claim data 220 may include, but is not limited to, claim type data 222, status data 224, date data 226, claim party data 228, voyage data 230, negotiation data 232, communication data 234, document data 236, and a change log 238. Although not illustrated in FIG. 2, the claim data 220 may further include an identifier that uniquely identifies the claim from all other claims stored in the data storage device 118. The unique identifier may constitute symbols, numbers, letters, bar codes, or combinations thereof, or any other form of identification that allows the claim management system 106 to distinguish the claim from all other claims. The claim data 220 may further include less, additional, or different data without departing from the spirit and scope of the description.

In one embodiment, the claim type data 222 identifies a claim from one of many different types. In one embodiment, each claim is assigned at least one specific claim type. In one embodiment, the various claim types may include a demurrage claim type, a despatch claim type, an expense claim type, and a freight claim type; however, additional claim types are envisioned. In one embodiment, a demurrage claim relates to a claim wherein a ship charterer or cargo buyer/seller breaches a charter party by exceeding the agreed upon laytime at a port. In one embodiment, a despatch claim relates to a claim wherein a ship charterer or cargo buyer/seller takes less time at a port than the agreed upon laytime, as stated in the charter party. In one embodiment, an expense claim type relates to claim wherein a party involved in the load or discharge operation of cargo makes a claim against another party for expenses incurred during the load or discharge. For example, a ship charterer may submit an expense claim to a cargo buyer/seller for terminal fees, and the like. In one embodiment, a freight claim relates to a claim wherein a shipbroker requests freight payment from the ship charterer.

The claim status data 224 identifies the current status of a claim in the negotiating process. In one embodiment, there may be many different claim statuses that can be associated with the claim status data 224. For example, the claim status may include draft, submitted, acknowledged, under negotiation, agreed, agreed (confirmed), settled, time barred, and archived. The draft status may identify a claim that has been created in the system, but has not yet been submitted to another party. Accordingly, the claim management system 106 may only allow a draft claim to be deleted. The submitted status, on the other hand, may represent a claim that has been submitted to another party or a receiver. The acknowledged status may represent a submitted claim that a receiver has acknowledged receiving. An under negotiation status may represent a claim that has received a counteroffer from a receiver or one that has been reopened after settlement or archival, as described in greater detail below.

Once negotiation is complete, an agreed status may represent that a party has agreed to the terms of an offer. Accordingly, a claim that has an agreed status may no longer be open for negotiation. Moreover, an agreed (confirmed) status may represent that the party submitting the terms of the offer that were agreed to has confirmed their agreement to the terms of the offer. A settled status may represent a claim that has been agreed to and is considered closed by the parties involved. For example, the issuer of the claim may designate the status of a claim as settled once both parties have agreed to the same terms of an offer to settle. However, a settled claim may be reopened by an issuer or another party. In such a case, the issuer or other party may reopen the claim upon discovering additional documentation or evidence supporting a different settlement amount. Accordingly, a claim that has been reopened may have a status of under negotiation. A time barred status may represent a claim that has been rejected by a party because it was filed after the time bar, as found in the charter party or cargo sales contract. Finally, an archived status may represent a claim that has been settled for a designated period of time without being reopened. However, fewer, additional, or different claim statuses are envisioned without departing from the spirit and scope of the disclosure. For example, there may be a claim status associated with each offer made, document uploaded, or comment. Thus, the claim status may be specific to each negotiation between the parties.

Returning to FIG. 2, claim data 220 may further include date data 226, which may identify one or more dates associated with the claim. Various dates may be used to track the claim, its status, and negotiations. For example, there may be dates associated with when the claim was created, submitted, acknowledged, when negotiations began and concluded, when the claim was agreed to, settled, archived and the like. In addition, there may be various dates associated with the negotiations, the voyage, the charter party and the like. For example, there may be a date associated with each offer, counteroffer, uploaded document, voyage time, charter party execution, and the like. Fewer, additional, or different dates are envisioned without departing from the spirit and scope of the description.

The claim party data 228 identifies one or more parties (e.g., companies, persons, etc.) associated with the claim. In one embodiment, the party may be a legal entity, as described above. Furthermore, the claim party data 228 may also include claim party type data. The claim party type data may be used to identify the relationship between the claim party and that claim. For example, claim party types may include an issuer, a creator, a receiver, a negotiator and/or an observer. Fewer, additional, or different claim party types are envisioned without departing from the spirit and scope of the disclosure.

In one embodiment, the issuer is one of the parties in the contract agreement, charter party, or cargo sales contract. The creator may be the same as the issuer. However, the creator and the issuer may also be distinct legal entities. In one embodiment, an issuer may grant another legal entity the authority to submit a claim on the issuer's behalf. For example, a ship owner may authorize a shipbroker to submit claims to a ship charterer on their behalf. In such an embodiment, the shipbroker is considered the creator and the ship owner is considered the issuer.

An observer may only be allowed, or enabled, to view the claim in the system, but not permitted to edit it. In some cases, an observer may also be enabled to comment on and upload documents for the claim. A negotiator may also be the creator of a claim. Moreover, in some embodiments, the negotiator may enabled to view the claim, edit the claim, upload documents for the claim, comment on the claim, accept offers or counteroffers for the claim, and otherwise negotiate settlement of the claim on behalf of a party. In one embodiment, there may be multiple creators, issuers, receivers, and/or negotiators associated with a claim.

Once a claim has been submitted, the creator, issuer, receiver, and/or negotiator may then commence negotiating settlement of the claim. The various parties may update the claim data 220, make counteroffers, submit communication data 234, upload document data 236, and the like until both parties come to an agreement, or negotiations otherwise end.

Referring further to FIG. 2, the voyage data 230 may identify one or more voyages associated with the claim. In one embodiment, the voyage data 230 includes ports, vessels, shipping dates, quantity of cargo, grade of cargo, contract identifiers for each party, trip identifiers for each party, and the like. Less, additional, or different voyage data 230 is envisioned without departing from the spirit and scope of the disclosure. The voyage data 230 may include any data that aids in the identification of the voyage, or voyages, associated with the claim.

The negotiation data 232 identifies the negotiations that are taking place between parties regarding the claim. In one embodiment, the negotiation data includes offers and counteroffers made between the parties, amounts offered, the initial amount of the claim, the settled amount of the claim, difference from the last offer made and the initial amount, notes, and the like. Less, additional, or different negotiation data 232 is envisioned without departing from the spirit and scope of the disclosure. The negotiation data 232 may include any data that aids the claim management system 106 in tracking, generating a display for and/or storing the negotiations associated with the claim.

The communication data 234 identifies communications between the parties negotiating the claim. The communication data 236 may include many different types of communication that occur between the parties. For example, the communication data 236, may include emails, instant messages, SMS, phone calls, recorded phone calls, pop-up windows, alarms, faxes and the like between the two parties beginning with the creation of the claim. In one embodiment, the communication data 236 may include communications that occurred before the claim was created. The communication data 236, may also include a log of all the communications that occur between the parties using the claim management system 106.

The change log 238 identifies a log tracking any changes that have occurred to the claim. In one embodiment, the change log 238 includes information relating to the any edits, updates, and/or system operations performed on the claim.

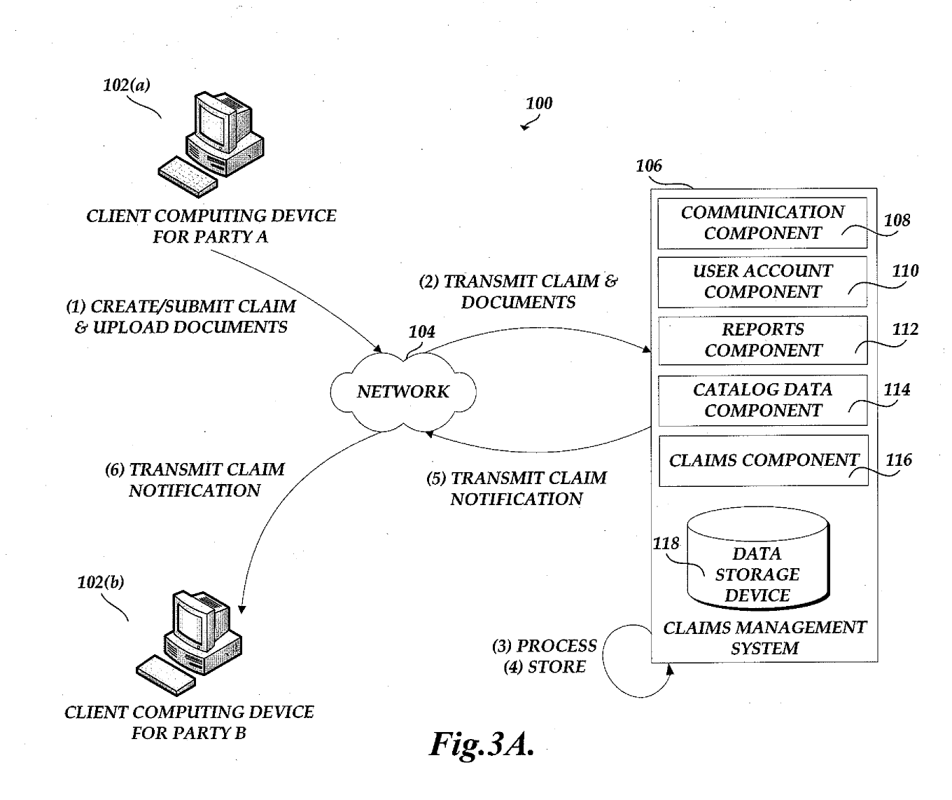

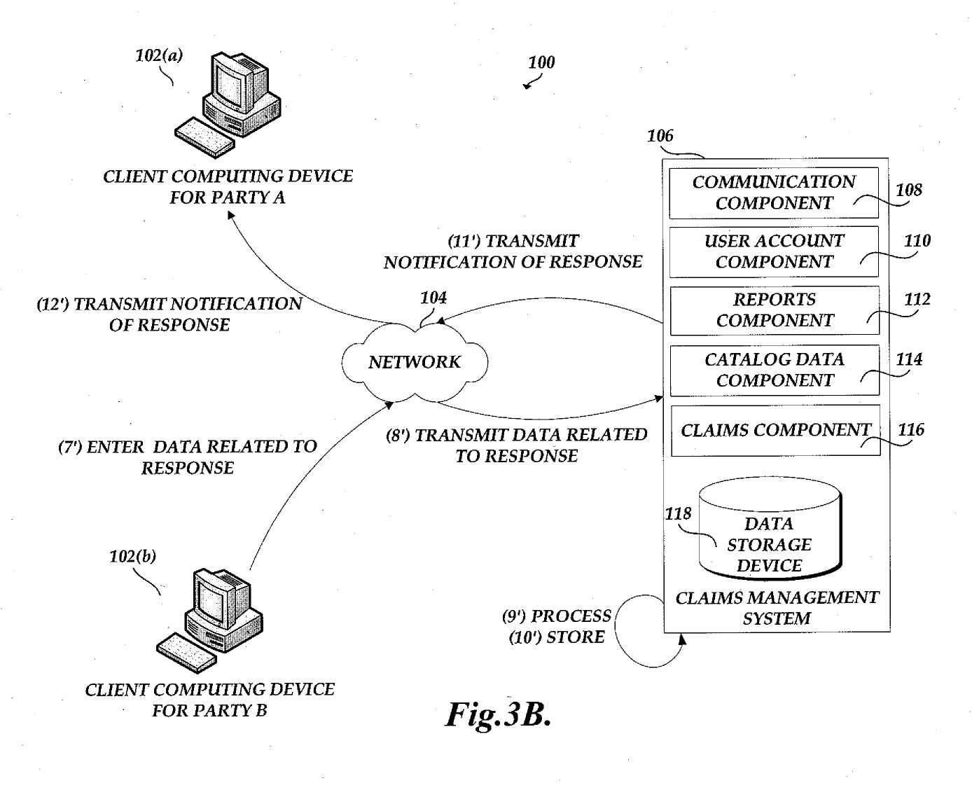

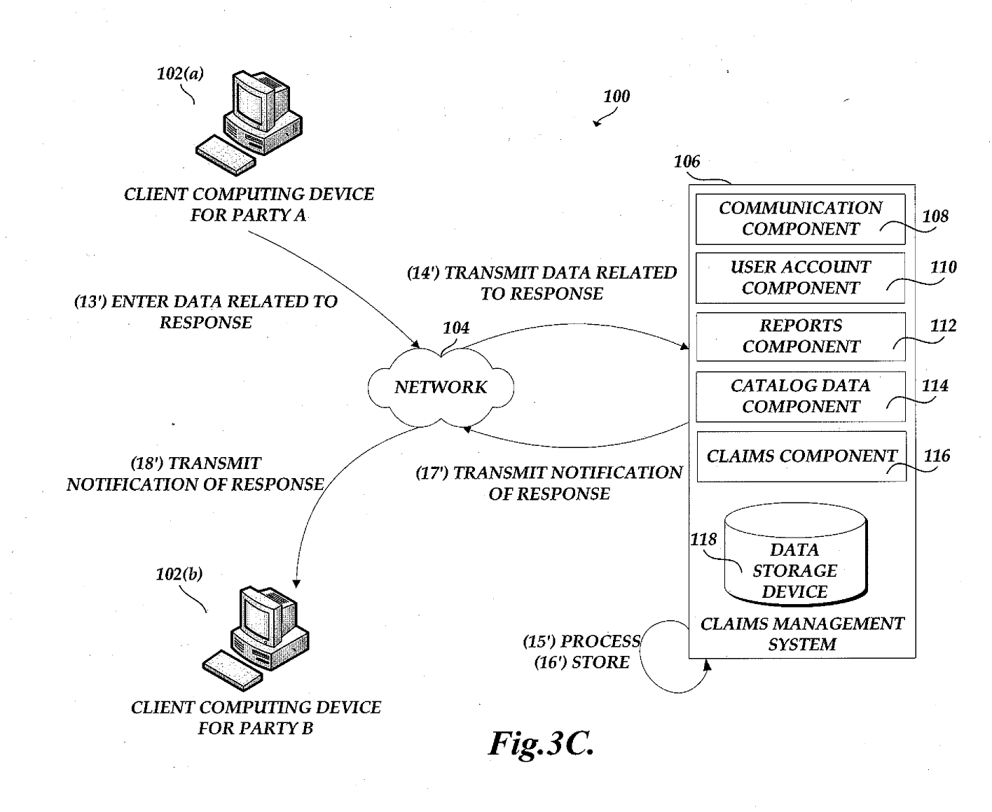

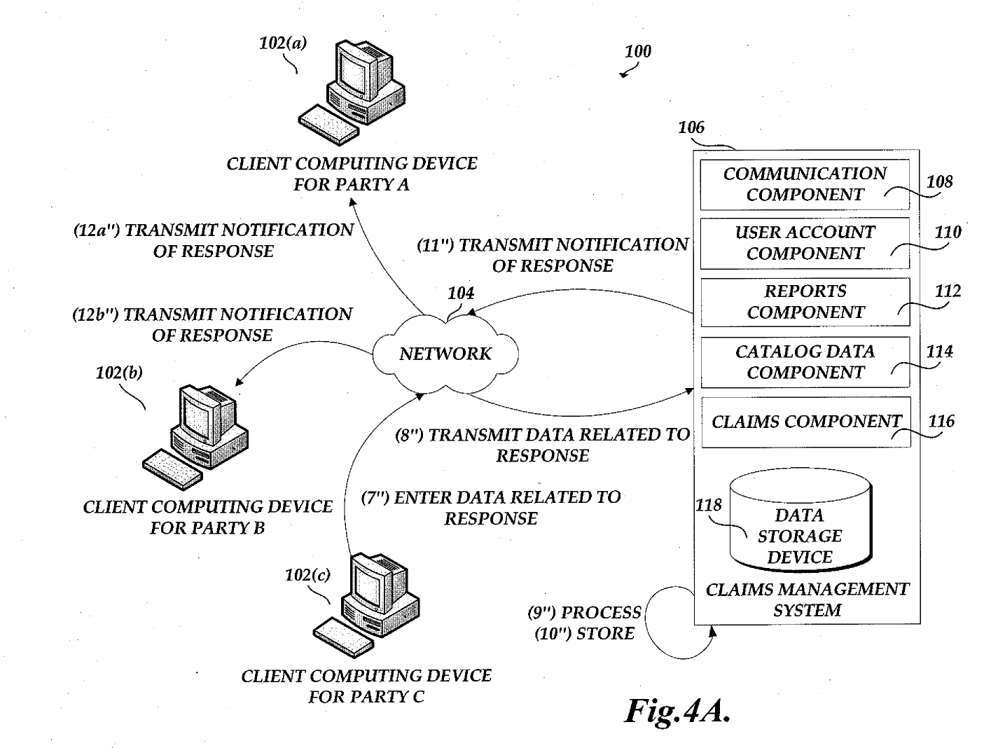

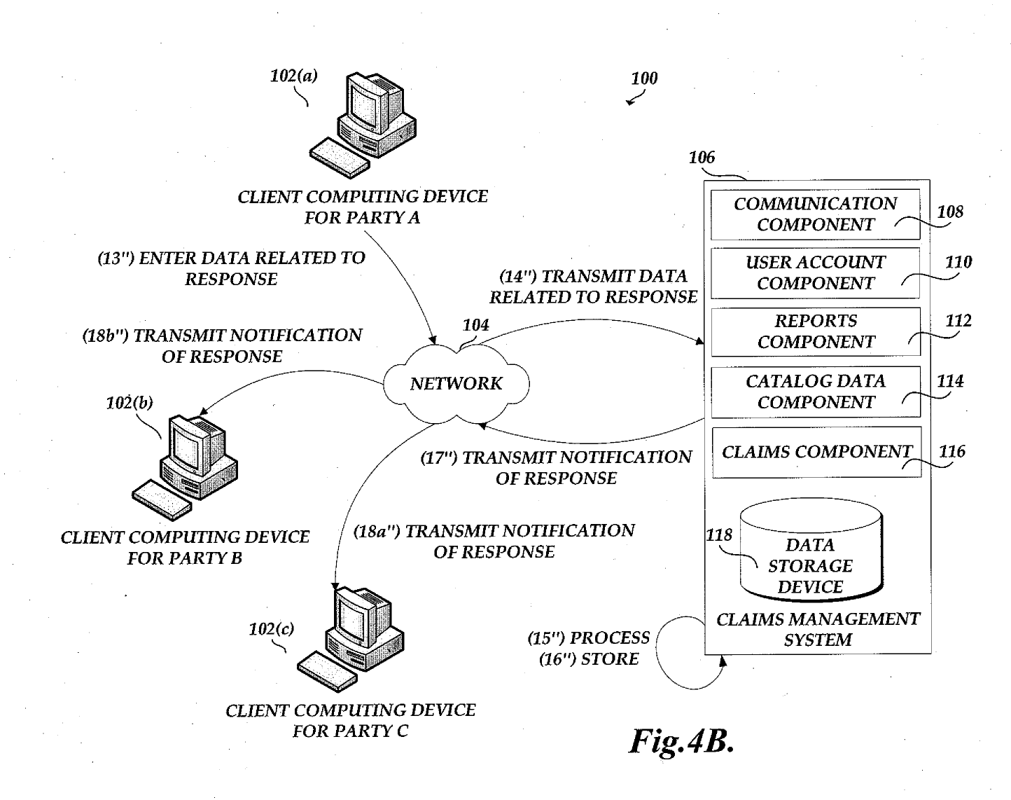

With reference now to FIGS. 3A, 3B, 4A, and 4B, the interaction between the various components of the claim management environment 100 of FIG. 1 is illustrated. For purposes of the example, however, the illustration has been simplified such that many of the components utilized to facilitate communications are not shown. One skilled in the relevant art will appreciate that such components can be utilized and that additional interactions would accordingly occur without departing from the spirit and scope of the present disclosure.

With reference to FIG. 3A, party A may create a claim utilizing a user interface generated by the claim management system 106. As discussed previously, in one embodiment, the party creating the claim is referred to as the creator. Thus, in illustrated example, party A is the creator. Party A may create the claim by entering claim data 220, including claim type data 222, claim status data 224, date data 226, claim party data 228, voyage data 230, negotiation data 232, communication data 234, and document data 236 via the user interface.

Furthermore, in this example, and not to be construed as limiting, party A is also the issuer and party 13 is the receiver. However, as noted above, in other examples party A may be the creator and another party may be the issuer. In yet other examples, one party may create the claim, another party may negotiate settlement of the claim and a third party may be the issuer. Similarly, the receiver may negotiate settlement of the claim or have a negotiator negotiate settlement of the claim on the receiver's behalf.

As an example, referring to FIG. 3A, as part of creating a claim, party A may calculate a demurrage owed of $100,000. Party A may then enter the claim data 220 associated with the calculation utilizing a user interface generated by the claim management system 106. Thus, party A may enter voyage data 230 including vessel information, dates of the voyage, cargo transported, the relevant contract dates, ports visited, and the like utilizing client computing device 102(a). It is envisioned that party A may submit less, additional, or different data without departing from the spirit and scope of the disclosure.

Party A may further submit receiver information including the name of the legal entity of the receiver, contact information, and the like utilizing client computing device 102(a). In this case, party A is identified as the issuer and party B is identified as the receiver. Party A may also enter claim type data 222 identifying the type of the claim as described above utilizing client computing device 102(a). Party A may also enter the claim status data 224 utilizing client computing device 102(a) to identify the status as a draft. In an alternative embodiment, the claim management system 106 may automatically determine the status of a claim. Party A may also include negotiator information identifying a negotiating party that is negotiating the claim on behalf of party A and/or party B. Upon receiving the information, the claim management system 106 may enable the negotiation party to edit the claim, make offers/counteroffers, accept an offer, and otherwise negotiate the claim on behalf of party A and/or party B. Party A may further upload documents in the form of document data 236, supporting the claim utilizing client computing device 102(a). For example, party A may upload the charter party identifying the agreed to laytimes, time logs showing the different laytimes and how party B breached the agreed to laytimes, fact sheets further supporting party A's conclusion that party B breached the charter party, and/or letters requesting despatch or demurrage. Less, additional, or different types of documents may be uploaded and are envisioned without departing from the spirit and scope of the description. Party A may also submit communications data 234 further giving context to or describing the claim and the calculations associated with the claim. In addition, party A may submit an offer amount to settle the claim. Furthermore, party A may submit identifying information of other legal entities so that the other legal entities can access the claim. Upon receiving the information, the claim management system 106 may enable the other legal entities to access the claim based on the indications by part A. In one embodiment, the legal entities may be observers. As described above, as an observer, the legal entities may have limited access to view and/or edit the claim data 220. Thus, the legal entities may be enabled to view and/or edit the claim data 220, but may be disabled from accepting and/or making and offer/counteroffer. In addition, as will be described below in greater detail with reference to FIGS. 4A and 4B, the legal entities may be negotiators and may be granted access, or enabled, to edit any and all claim data 220 and/or negotiate settlement of the claim.

In general, the creator may edit the draft claim in many different ways without departing from the spirit and scope of the disclosure. Furthermore, in an embodiment where the creator is separate from the issuer, the issuer may also be able to edit the claim data in any manner similar to that described above with reference to the creator. As will be described in greater detail below with reference to FIGS. 4A and 4B, a negotiator may also be able to perform any of the edits similar to those described with reference to the creator and the issuer.

Upon entering the claim data 220 associated with the claim, the client computing device 102(a) may transmit the claim data 220, including an offer to settle the claim, as well as any uploaded documents, to the claim management system 106 automatically or at the request of the creator, issuer, observer, and/or negotiator. As discussed previously, in one embodiment, a created claim that has not been submitted to another party may have a draft status and may be referred to as a draft claim. As also discussed previously, the creator may further edit or remove some or all of the claim data 220, including the offer made, upload additional document data 236, add communication data 234, add notes to any negotiation data 232, and the like.

With further reference to FIG. 3A, the claim management system 106 may process and store the data. The processing performed by the claim management system 106 may depend on the data transmitted. In one embodiment, in processing the claim data, the claim management system 106 may update one or more of the claim type data 222, status data 224, date data 226, claim party data 228, voyage data 230, negotiation data 232, communication data 234, document data 236, and/or change log data 238, in accordance with the data received. Thus, at times the claim management system 106 may update some, all or none of the claim data. For example, upon receiving the claim data 220 to create a claim, the claim management system 106 may edit all claim data 220. In another embodiment, the claim management system 106 may update only some of the claim data 220. In one embodiment, the claim management system 106 may further create/edit/delete any claim data 220 to track and process the claim.

It will be appreciated by one skilled in the art and others that the processing and storing functions performed by the claim management system 106 can be repeated as necessary and performed in any order. For example, storage of data associated with the creation of the claim can occur once all processing has been completed, intermittently with processing, or prior thereto. The claim management system 106 may also provide the results of its processing to the client computing device 102.

With continued reference to FIG. 3A, party A may select to submit the claim to party B using the claim management system 106. Although not illustrated, party A may use a user interface generated by claim management system 106 and/or the client computing device 102(a) to select to submit the claim to party B. The user interface may further enable party A to select another party to whom the claim will be submitted. In addition, the user interface may allow party A to select additional parties as negotiators, observers, and the like, for the claim. Upon selecting to submit the claim, the client computing device 102(a) may then transmit the submission to the claim management system 106.

As described above, the claim management system 106 may then process and store the submission as described above. In addition, in one embodiment, the claim management system 106 may transmit a notification to party B that the claim has been submitted. The notification may occur in any number of ways. For example, the claim management system 106 may transmit an email, an SMS, a phone call, an alarm, a fax, an instant message, a page, and/or a pop-up window, or the like to client computing device 102(b). In one embodiment, the notification may be executed automatically by the claim management system 106 once the claim is submitted or may require that party A request that party B be notified.

With reference to FIG. 3B, the party B may view and respond to the claim utilizing client computing device 102(b). Upon receipt of the notification, party B associated with client computing device 102(b) may perform any number of functions. Party B may accept the offer, respond that the claim is time barred, make a counteroffer, upload document data 236, submit communication data 234, and/or edit any other claim data 220 utilizing client computing device 102(b). Party B may perform additional functions without departing from the spirit and scope of the disclosure. Thus, party B may begin negotiation of settlement of the claim with party A. Furthermore, party B may user a user interface generated by the claim management system 106 and/or the client computing device 102(b) to perform these functions and enter the data related to their response. In one embodiment, party B, may use a user interface similar to that used by party A, but that includes some or all of the claim data 220 associated with the claim. In another embodiment, the different parties may use different user interfaces to interact with the claim management system 106.

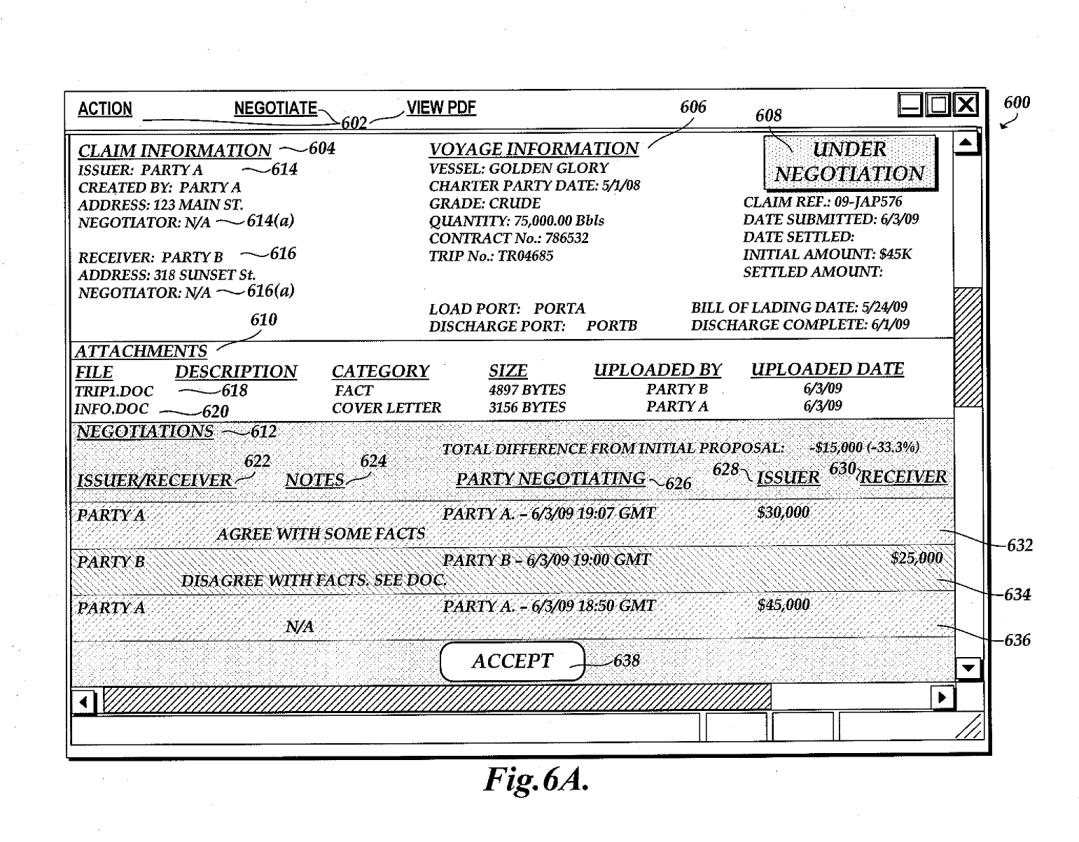

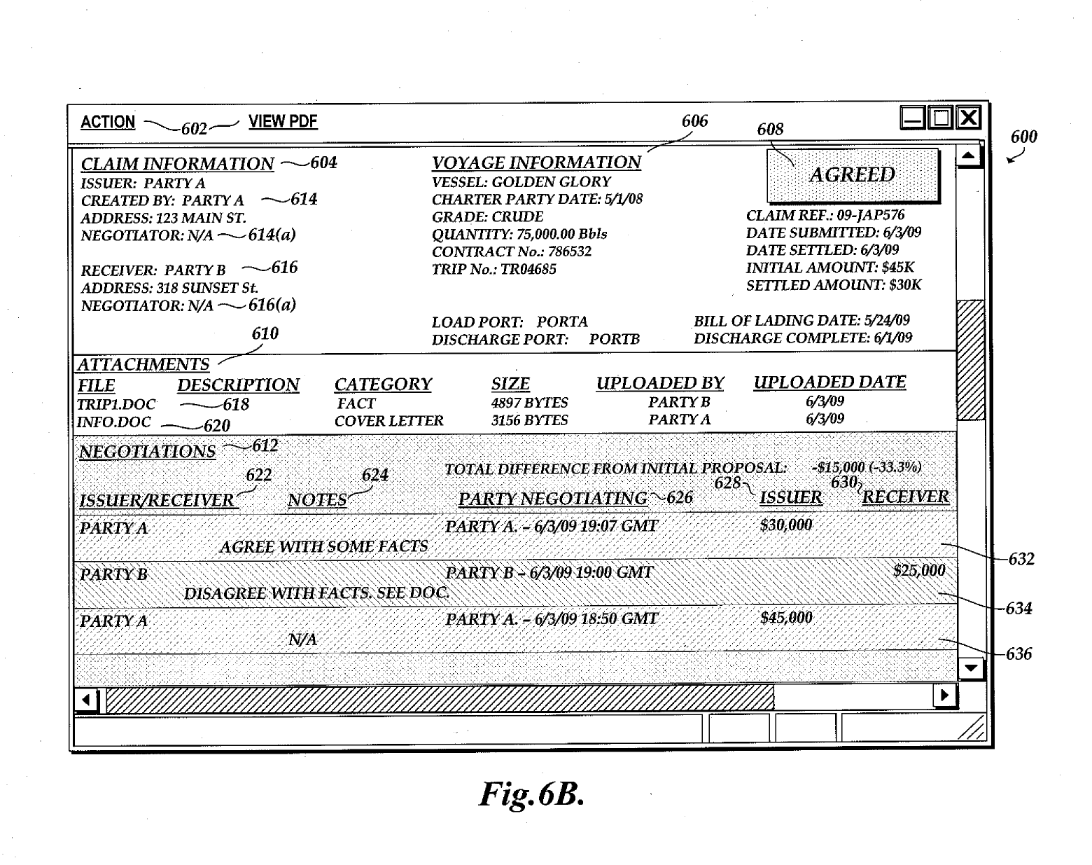

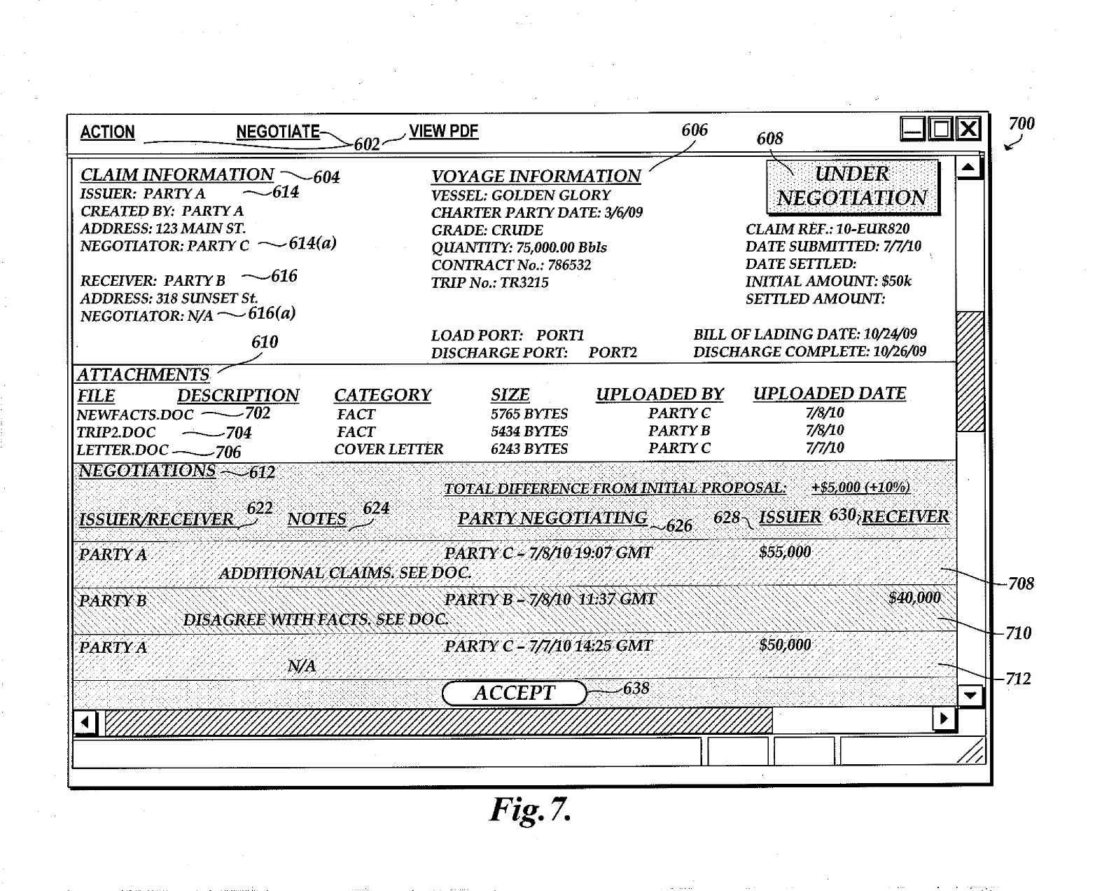

As an example, and not to be construed as limiting, party B may disagree with the amount of the offer made by party A ($100,000) and included in the claim data 220, and submit a counteroffer. Party B may have calculated a smaller sum of $50,000 owed as demurrage, and submit the smaller sum as part of the counteroffer. In addition, as part of the counteroffer, party B may upload document data 236 referencing the calculations and supporting the smaller sum. Party B may further submit communication data 234 regarding the counteroffer. The communication data 234 may include explanations of the calculations or the negotiations. In addition, party B may submit notes with the negotiation data 232 referencing and/or describing the document data 236 and its relevance to the counteroffer. Party B may further edit other claim data 220 as deemed appropriate. For example, if party B believes the date data 226 or voyage data 230 is incorrect, then he/she may edit that data. Although not illustrated in FIG. 3B, the claim management system 106 may generate a user interface provided to the client computing device 102(b) for use by party B. The user interface may enable party B to make all of the following counteroffers, edits, and negotiations described above. Furthermore, the user interface may be similar to the user interfaces described below with reference to FIGS. 6A, 6B, and 7.

Upon party B's request, client computing device 102(b) may then transmit the data related to party B's response to the claim management system 106. The response may be in the form of further negotiations, a counteroffer or an acceptance of an offer. Less, additional, or different types of responses are envisioned without departing from the spirit and scope of the description. The claim management system 106 may process and store the data received, as described above.

As an example, the claim management system 106 may edit the claim status data 224 depending on party B's response. If party B, accepts party A's initial offer the claim status data 224 may be changed from a submitted status to an agreed status. However, if party B acknowledges receipt of the initial offer or responds that the claim is time barred, then the claim management system 106 may change the status from submitted to acknowledged or time barred, respectively. Furthermore, if party B responds with a counteroffer, then the claim management system 106 may change the claim status data 224 to an under negotiation status. Once the claim management system 106 has changed the claim status data 224 to an under negotiation status, the claim may retain that status until the parties have agreed to an offer.

Furthermore, the claim management system 106 may edit claim data 220 as deemed appropriate. The edits may be performed automatically, or require authorization from a system administrator. For example, in some embodiments, any changes to the claim data 220 may require authorization from the issuer and/or creator. For example, if party B proposed different contract, charter party, or voyage dates, the claim management system 106 may edit the date data 226. Similarly, the voyage date 230 and other claim data 220 may be edited. In addition, if party B responded with an offer or counteroffer, the claim management system 106 may edit the negotiation data 232 accordingly. Additionally, the claim management system 106 may edit the document data 236 upon receipt of any documents uploaded by party B. Furthermore, the claim management system 106 may edit the log 238 to track the various edits taking place.

It will be appreciated by one skilled in the art and others that the processing and storing functions performed by the claim management system 106 can be repeated as necessary and performed in any order. For example, storage of data associated with the response by party B to the claim can occur once all processing has been completed, intermittently with processing, or prior thereto. The claim management system 106 may also provide the results of its processing to the client computing device 102.

With continued reference to FIG. 3B, and as similarly described above with reference to FIG. 3A, the claim management system 106 may transmit a notification of the response by party B to client computing device 102(a). As discussed above, the response may be negotiations, a counteroffer and/or an acceptance of an offer, and the notification may be executed using any number of methods.

With reference to FIG. 3C, the parties may continue to negotiate settlement of the claim. Similarly, party A may perform any number of functions similar to those described above for party B with reference to FIG. 3B. Thus, party A may respond to party B with another offer or counteroffer. Party A may also upload additional documents supporting his/her offer and claim, or submit additional communication data 234 clarifying his/her offer. Party A may also edit claim data 220 as deemed appropriate. Party. A, or some other party, may enter the data associated with their response utilizing a user interface. For instance, party A may disagree with the date data 226 submitted by party 13, or may realize an error in the date data 226 entered by himself/herself. Accordingly, party A may edit the date data 226. Similarly, party A may edit any other claim data 220 as deemed appropriate.

Upon request by party A or automatically, client computing device 102(a) may transmit the data to the claim management system 106. The claim management system 106 may process and store the data accordingly. As described earlier with respect to FIGS. 3A and 3B, the claim management system 106 may edit and/or highlight changes in claim data 220. For instance, the claim management system 106 may edit the claim status data 224 to reflect any changes to the status. For example, if party B stated that the claim was time barred and party A disputes the time bar, the claim management system 106 may edit the claim status data 224 from time barred to under negotiation. In such a case, the claim status data 224 will remain under negotiation until a settlement with respect to the time bar has been reached. The claim status data 224 may be further edited throughout the process as deemed appropriate, and as described above.

It will be appreciated by one skilled in the art and others that the processing and storing functions performed by the claim management system 106 can be repeated as necessary and performed in any order. For example, storage of data associated with the response by party A to party B's response can occur once all processing has been completed, intermittently with processing, or prior thereto. The claim management system 106 may also provide the results of its processing to the client computing device 102. For example, the claim management system 106 may provide the client computing device 102 with a report of the various updates made to the claim data 220.

Furthermore, the various interactions between the components of the claim management environment 100, may continue until settlement of a claim has been achieved, or until one or more of the parties withdraws from negotiation. Thus, party A and/or party B may continue to submit claim data 220, including offers made, document data 236, negotiation data 232, voyage data 230, date data 226, and the like utilizing client computing devices 102(a) and 102(b), respectively, until settlement of the claim is reached. Accordingly, the claim management system 106 will continue to track the history of the negotiations and the offers made between the different parties until an agreement to an offer made has been accepted. In one example, the accepted offer may be the last offer made. The party accepting the offer may be presented with a user interface similar to that described below with reference to FIGS. 6A and 7, which may include a history of offers made, a status indicator, and an acceptance control. In one example, the acceptance control may be associated with the last offer made. Utilizing a client computing device 102, a party may accept the offer by selecting the acceptance control. Upon selection of the acceptance control by the party utilizing the client computing device 102, the claim management system 106 may automatically update the claim status data 224 to accepted. Furthermore, the claim management system 106, may further automatically notify the parties related to the claim of the acceptance, upon selection of the acceptance control. The notification may include, but is not limited, to, email, an SMS, a phone call, an alarm, a fax, an instant message, and/or a pop-up window, and the like. Alternatively, the claim management system 106 may receive additional communication data 234 from the accepting party before notifying the parties of the acceptance. For example, the accepting party may add comments regarding the reasons for accepting the offer to settle, and the like.

In addition, it is to be understood that the parties may also cancel an existing offer/counteroffer that they have proposed and submit a different or revised offer/counteroffer utilizing a client computing device 102 before the other party has responded. In addition, it is to be understood that the parties need not wait for the other party to respond before submitting additional or revised claim data, uploading documents and the like utilizing a client computing device 102. Accordingly the claim management system 106 may process and store the data, as described above, and notify the other party of the additions/changes.

Once the parties have agreed to an offer made using a user interface similar to that described below with reference to FIGS. 6A and 7, the acceptance may be transmitted to the claim management system 106 by the client computing device 102 associated with the party accepting the offer. As part of the processing, the claim management system 106 may update the claim status data 224 from submitted, time barred, under negotiation, or the like to agreed. The claim management system 106 may then generate a notification for, and notify the party that made the accepted offer. As discussed above, notification may be in the form of email, an SMS, a phone call, an alarm, a fax, an instant message, and/or a pop-up window, and the like. Furthermore, the generation of the notification and the notifying of the party may be executed automatically by the claim management system 106, or may require additional processing before being completed. For instance, the party utilizing a client computing device 102 may via a user interface specifically request that the notification be sent, enter additional communication data 234 before the notification is sent, or the like. In one embodiment, the party that made the accepted offer may then acknowledge their agreement utilizing a client computing device 102. The respective client computing device 102 may then transmit the acknowledgement of the agreement. The claim management system 106 may then edit the claim status data 224 from agreed to settled. In another embodiment, once a party has agreed to an offer utilizing a client computing device 102, the other party need not acknowledge the agreement. In such an embodiment, the claim management system 106 may edit the claim status data 224 from under negotiation to agreed to settled without receiving additional data from the other party.

Upon completion of the negotiation of settlement of the claim, the claim management system 106 may store the data, as described above. After a set amount of time has elapsed and the settled claim has not been reopened, the claim management system 106 may archive the settled claim. In one embodiment, the claim management system 106 may archive the claim after it is has been settled for more than one year.

Furthermore, as part of processing data throughout the claim management process, the claim management system 106 may update the user interface and/or generate other user interfaces to reflect any changes to the claim data. Thus, throughout the claim management process, the claim management system 106 may generate a user interface to present some or all of the claim data 220 for use by one or more of the parties associated with the claim. As will be described in greater detail below, the user interface may include claim data 220, including voyage claim type data 222, claim status data 224, date data 226, voyage data 230, negotiation data 232, communication data 234, document data 236, and the like. Additional data may be included as part of the user interface without departing from the spirit and scope of the description. Furthermore, upon processing the various requests, and data, the claim management system 106 may update the user interface and/or generate other user interfaces accordingly. For instance, each time the claim status data 224 is edited by the claim management system 106, the claim management system 106 may update the user interface to reflect the change. Additionally, as any other claim data 220 displayed on the user interface is edited by the claim management system 106, the claim management system 106 may update the user interface accordingly. Thus, the user interface(s) may reflect changes to the date data 226, voyage data 230, negotiation data 232, communication data 234, document data 236, and the like. Furthermore the user interface(s) may include more or less data without departing from the spirit and scope of the disclosure.

In addition, the user interface(s) may include additional features and controls depending on the claim data 220 stored in the data storage device 118. For example, if the claim status data 224 is an under negotiation status, then the user interface may include an acceptance control. Upon selection of the acceptance control the claim management system 106 may automatically update the claim status data 224 and user interface accordingly. In addition, the claim management system 106 may automatically notify the other party of the acceptance.

With reference to FIGS. 4A and 4B, an alternative embodiment is described, wherein a negotiator negotiates settlement of the claim utilizing a client computing device 102(c). In the embodiment illustrated in FIGS. 4A and 4B, party C is granted access by party B, to negotiate on behalf of party B. Thus, in this case, and not to be construed as limiting, party A is the issuer, party B is the receiver and party C is a negotiator negotiating on behalf of party B. It is envisioned that party C may represent either party A or party B. Furthermore, both party A and party B may use negotiators to negotiate settlement of the claim. In addition, one or both parties may use multiple negotiators to negotiate settlement of the claim.

Similar to FIG. 3A, party A creates and submits the claim utilizing a client computing device 102(a), the claim management system 106 processes and stores the claim data as described in greater detail above, and notifies party B using the communication network 104 to communicate with client computing device 102(b). In this example, party A is the creator and issuer and party B is the receiver. Either the issuer or the receiver may utilizing the claim management system 106 grant access, to the claim and claim data to a negotiator who may then act on behalf of that party. Granting access to a party may also be referred to as enabling a party. The parties may grant access, or enable, in any number of ways. For example, the parties may give a third party an access code, password, username or the like, which may grant the party access. Alternatively, the granting party may submit data regarding the third party to the claim management system 106. Upon receiving the data regarding the third party, the claim management system 106 may grant access, or enable, a party to perform one or more different operations depending on the indications given by the granting party or by indications stored within the claim management system 106. The claim management system 106 may also notify the third party of the access being granted. This notification may occur in any number of way including, but not limited to email, an SMS, a phone call, an alarm, a fax, an instant message, and/or a pop-up window, or the like. Furthermore, the claim management system 106 may notify some or all other parties related to the claim that access has been granted to an additional party. The notification may be in a form similar to that described above. The notification may further include information regarding the additional party including the level of access granted to that party. For example, if an issuer grants a third party access as a new negotiator, the issuer, receiver, new negotiator and any other negotiators and/or observers associated with the claim may receive an email, SMS, voicemail, or other type of message indicating the identity of the new negotiator and the level of access the new negotiator has, such as the ability to edit claim data 220, upload documents, make offers/counteroffers, and the like on behalf of the issuer. Alternatively, the claim management system 106 may only notify some of the parties related to the claim. For example, only the issuer and the new negotiator may be notified.

With further reference to FIG. 4A, and not to be construed as limiting, party B grants access to party C to negotiate the claim on the receiver's behalf. Thus, party C is a negotiator. As described above, the claim management system 106 may grant varying levels of access to party C, or otherwise enable party C to perform a number of different operations at the request of party B. For example, the claim management system 106 may grant access to, or enable, party C to view the status of the claim, view the offers made, upload documents, communicate, and/or negotiate the claim. In another example, the claim management system 106, party A and/or party B may grant access to, or enable, multiple parties as negotiators and/or observers.

In another example, party C may be granted access to the claim as an observer. Party C may be a party involved, either directly or tangentially, in the contract and may have documents to support party B's response. Alternatively, party A may grant access to party C similar to the access granted to party C by party B. Furthermore, additional parties may be granted access by either party A or party B to view the claim, submit documents, communicate or negotiate the claim. The additional parties may be identified as observers or negotiators, and may have varying levels of access granted to them with regards to the claim. Thus, many parties may be granted varying levels of access to the claim without departing from the spirit and scope of the disclosure.

With further reference to FIG. 4A, party C, having been granted access, may make offers/counteroffers to settle the claim, communicate on behalf of party B, upload documents, accept an offer or counteroffer submitted by party A, and otherwise negotiate settlement of the claim utilizing client computing device 102(c). Party C, or some other party, may enter the data associated with their response using a user interface. Upon receiving the transmitted documents, offers/counteroffers, acceptance, and/or communications, the claim management system 106 may process and store the received data as discussed above with regards to FIGS. 3A and 3C. The claim management system 106 may then notify the issuer of the offers/counteroffers, communications, acceptance, and/or documents submitted by party C also similarly described above with reference to FIGS. 3A and 3C. In one embodiment, in addition to notifying party A of party C's response, the claim management system 106 may further notify party B of the ongoing negotiations utilizing similar techniques described above. For example, party B may receive via client computing device 102(b) an email, SMS, voicemail, pop-up window, or the like, notifying party B of the negotiations. Thus, despite party C negotiating settlement of the claim on behalf of party B, party B may still be apprised of the status of the negotiations and the termination.

Although not illustrated in FIG. 4A, party B may still negotiate settlement of the claim and may upload documents, submit communications, transmit offers/counteroffers, accept an offer/counteroffer that has been proposed, and the like utilizing client computing device 102(b). In another example, once party B has granted access to party C, party B may be granted limited access, or otherwise be disabled from performing some or all operations. For example, upon granting access to party C, party B may only have access, or only be enabled, to view the status of the claim and/or upload documents related to the claim. In such an example, party B would be disabled from accepting and/or submitting offers, editing claim data 220, and the like. In yet another example, party B may have access, or be enabled, to submit communications and/or make an offer, but may be disabled from uploading documents. Thus, it will be understood that upon granting access to party C, party B may retain access to some, all or none of the various activities associated with negotiating settlement of the claim. In other words, party B may be disabled from performing some, all, or none of the various activities associated with negotiating settlement of the claim, upon enabling party C to perform some, or all of the various activities associated with negotiating settlement of the claim.

With reference to FIG. 4B the various parties may continue to negotiate the settlement of the claim utilizing the respective client computing devices 102. Upon receiving the notification of an offer/counteroffer, acceptance of an offer made and/or uploaded documents, updated claim data 220, and/or the like, party A may perform activities similar to those described for party B and party C with reference to FIG. 4A. Thus, party A may make an offer/counteroffer, submit a communication, upload a document, and/or accept a proposed offer/counteroffer, and otherwise negotiate the settlement of the claim utilizing client computing device 102(a). Party A, or some other party, may enter the data associated with their response utilizing a user interface. The client computing device 102(a) may then submit the data associated with the negotiations to the claim management system 106. The claim management system 106 may then process and store the data as described above with regards to FIGS. 3A-3C. Also as described above, the interaction between the various components of the claim management environment 100 may continue until one party has accepted an offer/counteroffer of another party or the parties have withdrawn from negotiation.

Upon completion of negotiation of settlement of the claim, the claim management system 106 may store the data as described above. After a set amount of time has elapsed and the settled claim has not been reopened, the claim management system 106 may archive the settled claim. In one embodiment, the claim management system 106 may archive the claim after it is has been settled for more than one year.

In addition, it is to be understood that the parties may also cancel an existing offer/counteroffer that they have proposed and submit a different or revised offer/counteroffer before the other party has responded. In addition, it is to be understood that the parties need not wait for the other party to respond before submitting additional or revised claim data, uploading documents and the like. Accordingly the claim management system 106 may process and store the data and notify the other party of the additions/changes.

Furthermore, as part of processing data throughout the claim management process, the claim management system 106 may update the user interface(s) displayed on the client computing devices 102 to reflect any changes to the claim data. Thus, throughout the claim management process, the claim management system 106 may generate one or more user interface(s) to present some or all of the claim data for use by one or more of the parties associated with the claim. As will be described in greater detail below, the user interface may include claim data 220, including voyage claim type data 222, claim status data 224, date data 226, voyage data 230, negotiation data 232, communication data 234, document data 236, and the like. Less, additional, or different data may be included as part of the user interface(s) without departing from the spirit and scope of the description. Furthermore, upon processing the various requests, and data, the claim management system 106 may update the user interface(s) accordingly. For instance, in one embodiment, each time the claim status data 224 is edited by the claim management system 106, the claim management system 106 may update the user interface(s) to reflect the change. Additionally, as any other claim data 220 displayed on the user interface is edited by the claim management system 106, the claim management system 106 may update the user interface accordingly. Thus, the user interface(s) reflect changes to the date data 226, voyage data 230, negotiation data 232, communication data 234, document data 236, and the like. Furthermore the user interface(s) may include more, less, or different data without departing from the spirit and scope of the disclosure.

In addition, the user interface(s) may include additional features and controls depending on the claim data 220 stored in the data storage device 118. For example, in one embodiment, if the claim status data 224 is an under negotiation status, the user interface may include an acceptance control. The acceptance control may be associated with a last offer made by one of the parties utilizing a client computing device 102. Upon selection of the acceptance control the claim management system 106 may automatically update the claim status data 224 and user interface accordingly. In addition, the claim management system 106 may automatically notify the other party of the acceptance.

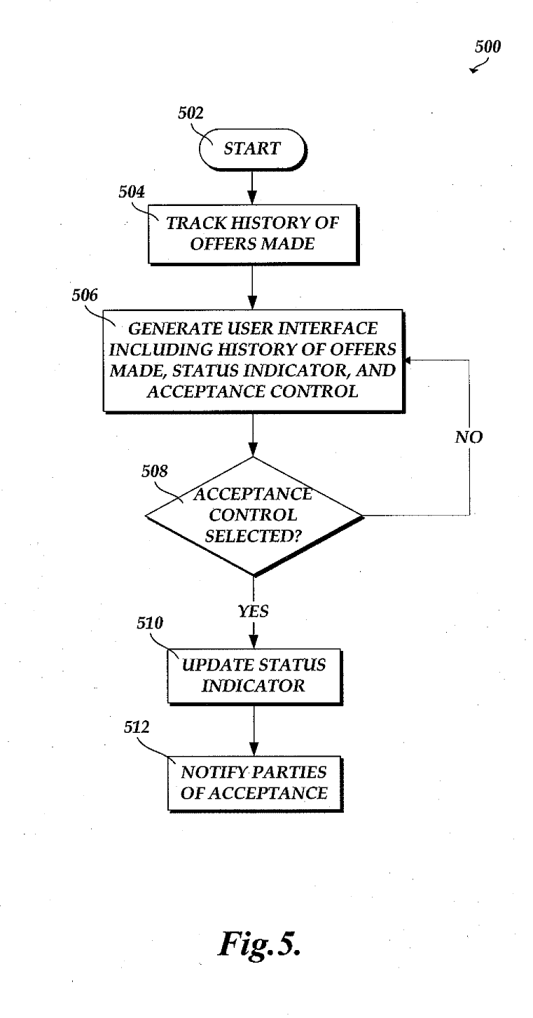

FIG. 5 is a flow diagram illustrative of one embodiment of a routine 500 implemented by a claim management system 106 for automatically notifying parties upon selection of an acceptance control. For example, routine 500 can apply to embodiments described above with reference to FIGS. 3A, 3B, 3C, 4A and 4B, and below with reference to FIGS. 6A, 6B, and 7. One skilled in the relevant art will appreciate that the elements outlined for routine 500 may be implemented by one or many computing devices/components that are associated with the claim management system 106. Accordingly, routine 500 has been logically associated as being generally performed by the claim management system 106, and thus the following illustrative embodiments should not be construed as limiting.

At block 502, the claim management system 106 initiates routine 500. At block 504, the claim management system 106 tracks the history of offers made by various parties to settle a claim.

At block 504, the claim management system 106 generates a user interface to be presented at a client computing device 102. In one embodiment, the user interface includes a history of offers made by various parties to settle a claim, a status indicator, and an acceptance control similar to that shown in FIGS. 6A, 6B, and 7. The claim management system 106 may generate one or more user interface(s) for each party associated with the claim being negotiated. The user interface(s) may be similar to each other, or may be configured differently depending on the party accessing the user interface. For example, the acceptance control of the user interface used by the party (including any negotiators and/or observers associated with that party) that submitted the last offer may be disabled. The acceptance control may be disabled by being inoperable, not shown, grayed out, inaccessible or the like. Thus, the party (including any negotiators associated with that party) that did not submit the last offer may be enabled to select the acceptance control. In addition, the acceptance control on the user interface(s) generated for parties that are observers may also be disabled.

The status indicator may reflect a current status of the claim based at least in part on the status data 224. The claim management system 106 may generate the status indicator in any number of ways, and it may be displayed on the user interface in any location. Furthermore, the status indicator may be any one of a button, a dial, a pop-up window, a screen color, or the like to indicate the status of the claim. Furthermore, upon a claim status change, the status indicator may change colors, sizes, blink, flash or the like to indicate the status change. Furthermore, the claim management system 106 may selectively generate the status indicator for various parties. For example, the claim management system 106 may disable a status indicator for an observer with limited access. Furthermore, the claim management system 106 may generate the status indicator differently for each party.

The acceptance control may be associated with one or more of the offers and allows a user to accept the offer with which it is associated. In one embodiment, the acceptance control is associated with the last offer made. The claim management system 106 may generate the acceptance control in any number of ways, and it may be displayed on the user interface in any location. As discussed above, the claim management system 106 may selectively generate the acceptance control for the various parties associated with a claim. For example, the claim management system 106 may only generate the acceptance control for the party (including any negotiators and/or observers of that party) that did not submit the last offer made. In addition, the claim management system 106 may generate the acceptance control for a party reviewing the last offer made, but once the party submits a counteroffer, additional negotiations, documents or the like, the claim management system 106 may reconfigure the user interface and disable the acceptance control based on the access granted or the operations that the party is enabled to perform, as discussed above. In addition, the claim management system 106 may generate a different acceptance control for each party associated with the claim. For example, the acceptance control may differ in size, shape, location, or the like depending on the party. Furthermore, each party may select how the claim management system 106 is to generate the acceptance control for that party. Additionally, the acceptance control may be associated with any one of the offers including the last offer made.

As will be explained in greater detail below with reference to FIGS. 6A, 6B, and 7, the user interface may further include claim information, including contract party and negotiating party information, voyage information, and the like.

At decision block 508, the claim management system 106 determines whether the acceptance control has been selected. The selection of the acceptance control may occur in any number of ways. For example the acceptance control may be selected using a mouse, keyboard, touch, light activation, sound activation, or the like.

If the claim management system 106 determines that the acceptance control has not been selected, routine 600 returns to block 506 and generates the user interface including the history of offers made, the status indicator and the acceptance control. Although not illustrated in FIG. 5, upon generating the user interface, the claim management system 106 may update the user interface with any additional information that has been received. For instance, the claim management system 106 may receive additional offers, counteroffers, documents, communications, and the like. Upon generating the user interface as illustrated in block 506, the claim management system 106 may include any of the additional data received.

On the other hand, if the claim management system 106 determines that the acceptance control has been selected, then the claim management system 106 updates the status indicator as illustrated in block 510. As discussed above, upon updating the status indicator, the claim management system 106 may generate a status indicator that differs in size, shape, color, text, or location from the previous status indicator. Furthermore, claim management system 106 may generate a different status indicator for each party associated with the claim and/or may not generate a status indicator for some parties associated with the claim. In addition, upon updating the status indicator, the claim management system 106 generates a status indicator that indicates the new status of the claim. In one example, the status indicator is updated from indicating under negotiation to accepted. The claim management system 106 may update the status indicator in any number of different ways. Generally, the claim management system 106 updates the status indicator for each party associated with the claim that may view a status indicator, however, the claim management system 106 may only update the status indicator of the party that selected the acceptance control or some other party. The status indicator may be presented in any number of ways as will be described in greater detail below with reference to FIGS. 6A and 6B.

With continued reference to FIG. 5, in one embodiment, routine 500 notifies the parties related to the claim that the last offer made has been accepted. The notification may occur automatically once the acceptance control has been selected or may occur at the request of a party. The parties may be notified in any number of ways including receiving an email, SMS, voicemail, pop-up window or the like utilizing a client computing device 102.

FIGS. 6A-6B illustrate one embodiment of a user interface 600 generated by the claim management system 106 before and after an acceptance control has been selected. More specifically, FIG. 6A illustrates user interface 600 before an acceptance control 638 is selected, and FIG. 6B illustrates user interface 600 after the acceptance control 638 has been selected. FIGS. 6A and 6B will now be described in greater detail. With respect to user interface 600, one or many parties may have access to the user interface 600. In one embodiment, all parties associated with a claim may have access to a user interface 600, and may view the same information. In another embodiment, the various parties may have access to different information from user interface 600 or may only be enabled to view parts of user interface 600 depending on the access granted, or the party type data 212 associated with an account. For example, the issuer and the receiver of a claim, may be enabled to view all of the information seen in user interface 600, while an observer may only be allowed to view the status indicator 608 and attachment information 610. In another example, the observer may be enabled to view the negotiation summary information 612, as well as the status indicator 608 and attachment information 610. In yet another example, the acceptance control 638 may be generated only for a party reviewing the last offer made by another party. In such an example, the claim management system 106 may disable an acceptance control 638 for the party that submitted the last offer. Thus, the party that did not submit the last offer may be enabled to select the acceptance control 638. In addition, the acceptance control 638 may be disabled for a party that is designated as an observer, or a party that has given access to a third party negotiator to negotiate on their behalf. As discussed above, the acceptance control 638 may be disabled by not being generated, not being displayed, being inoperable, being colored out, or the like. Thus, the user interface 600 may be configured based on the level of access of a party, or what the party is enabled to perform. Furthermore, the acceptance control may be enabled or disabled for a party based on the access granted to that party. Less, additional, or different information may be presented in user interface 600 for each party associated with the claim without departing from the spirit and scope of the description.

FIG. 6A is an illustrative user interface 600 before an acceptance control is selected. As illustrated, user interface 600 may be generated by the claim management system 106 for use by any party related to the claim being negotiated and/or as found in claim party data 228. However, as mentioned above, not all of the elements shown in user interface 600 may be generated for every user. For example, the acceptance control 638 may only be generated or enabled for the party that is reviewing an offer made by another party. Accordingly, in such an example, acceptance control 638 may be disabled, as discussed above. As illustrated, the user interface 600 may comprise links 602, a claim status indicator 608, claim information 604 associated with claim data 220, voyage information associated with voyage data 230, attachment information 610 including uploaded document information (618, 620) associated with document data 236, negotiation summary information 612 associated with negotiation data 232, and the like. Other embodiments, including more, less, or different data are envisioned without departing from the spirit and scope of the description. For example, the user interface 600 may include account information, related claims, and the like.

The links 602 may include references to additional processing or components of the claim management system 106. The links may be uniform resource identifiers, tiny links or the like that allow a user to navigate to a different user interface, display, web page, or the like. There may be one or more links associated with the user interface 600. As an example, and not to be construed as limiting, with reference to FIG. 6A, user interface 600 includes an action link, negotiate link, and view pdf link. Each link may be associated with a different user interface, different processing or a different component. For example, selecting a link may cause the claim management system 106 to generate a different user interface in accordance with the link selected. With further reference to the links 602, the action link may allow a party to view the various actions they may take with regard to a claim. The negotiate link may allow a party to enter additional negotiation data 232, update load document data 236, add/edit voyage data 230, grant access to other legal entities, and the like. In another embodiment, the above referenced activities may be performed on user interface 600. The view pdf (portable document format) link may allow a user to view a pdf of a report 204 associated with the claim. Although not illustrated in FIG. 6A, the view pdf link may be associated with any document viewer, editor, or the like and is not limited to pdf files. Various other links are envisioned to allow a user to more easily navigate the user interface 600 and use the claim management system 106.

The claim information 604 may reflect various pieces of information related to a claim. The claim information may include identifying information for the creator, issuer receiver, and any negotiators being used. The claim information 604 may further include other identifying information regarding the claim such as the date it was submitted and settled, the initial amount and settled amount, a claim identifier, and the like. Additional information to aid in the identification of the claim and to facilitate comprehension may be included and is envisioned without departing from the spirit and scope of the disclosure.

The claim status indicator 608 may be associated with the claim status data 224, and may include information allowing a party to easily identify the current status of a claim. In one embodiment, the claim status indicator may be a screen color, or format. The claim status indicator 608 may be presented in one or many locations of the user interface 600. Furthermore, multiple claim status indicators 608 may be presented on user interface 600. In addition, the claim status indicator 608 may change color, flash, blink, or the like each time the claim management system 106 updates the claim status indicator 608. In addition, the various claim status types may be associated with a different claim status indicator 608. For example, in one embodiment, each claim status type may be associated with a color, and the claim status indicator 608 may change color based on the claim status currently being indicated.

The voyage information 606 may be associated with the voyage data 230 and may include information to help identify the voyage with which the claim is associated. Such information may include a vessel name, a charter party date, the type and grade of cargo, the quantity of cargo transported by the vessel, contract numbers and/or trip identifiers for the voyage for each of the parties involved, port information, bill of lading and complete date information. Additional information to aid in the identification of the voyage and to facilitate comprehension may be included and is envisioned without departing from the spirit and scope of the disclosure.

The uploaded document information (618, 620) may be associated with the document data 236 and may include identifying information for each document that has been uploaded by a party. This information may include a category of the document such as a cover letter, fact sheet, or the like. Additional information may include the size of the document the party that uploaded the document and the date it was uploaded. The uploaded document information (618, 620) may further include a link to a copy of the document for ease of viewing.

The negotiation information 612 may comprise a number of different columns (622-630) for displaying data associated with the negotiation of a claim. The columns may include a contract party column 622, a notes column 624, a party negotiating column 626, an issuer offer amount column 628, and a receiver offer amount column 630. The negotiation information 612 may further include a history of offers made. The offers made may include information relating to the contract parties, notes between the parties, information regarding the party submitting the offer, and an offer amount. The negotiation information 612 may include more or less columns without departing from the spirit and scope of the description.

FIG. 6B is an illustrative user interface 600 after an acceptance control 638 is selected. User interface 600 of FIG. 6B may be generated by the claim management system 106 for all parties related to the claim being negotiated and/or as found in claim party data 228. As discussed above, some or all of the information illustrated in user interface 600 of FIG. 6B may not be generated for some users. Thus, user interface 600 of FIG. 6B is similar in most respects to user interface 600 of FIG. 6B with some exceptions. For example, the claim management system 106 has updated the status indicator 608 to reflect the change in status after the acceptance control 638 was selected. Furthermore, the claim management system 106 updated claim data 220 to reflect the settlement amount and the date the settlement was reached. In addition, the claim management system 106 disabled the acceptance control 638.

FIG. 7 is an illustrative user interface 700, which is an alternative embodiment of user interface 600. User interface 700 may be generated by the claim management system 106 for all parties related to the claim being negotiated and/or as found in claim party data 228. As illustrated in FIG. 7, user interface 700 retains many features similar to user interface 600. However, user interface 700 reflects a claim wherein at least one negotiator, party C, is negotiating settlement of the claim on behalf of the issuer, party A. The claim data 604 reflects the differences. Notably, negotiator data 614(a) is populated with the information identifying party C as the negotiator. In addition the uploaded files data, and offers made illustrate that party C is negotiating on behalf of party A. Specifically, the uploaded by column, illustrates that the newfacts.doc document 702 and the letter.doc document 706 were uploaded by party C. In addition, the party negotiating column 626 reflects that party C submitted the offers and notes on behalf of party A.

The claim management system 106 may generate user interface 700 as illustrated for party A, party B, and party C. Alternatively, as discussed above, user interface 700 may differ for each party associated with the claim. For example, as illustrated in FIG. 7 and not to be construed as limiting, the last offer made 708 was made by party C on behalf of party A. As such, the claim management system 106 may generate user interface 700 for party A and party C with a disabled acceptance control 638. Thus, party B may be the only party enabled to select acceptance control 638.

Had offer 710, made by party B, been the last offer made, the claim management system 106 may generate user interface 700 with a disabled acceptance control 638 for party B. In such an example, both party A and/or party C may be enabled to select the acceptance control 638. As such, party C on behalf of party A may be enabled to accept offer 710 made by party B. In an alternative embodiment, the user interface 700 generated for party A may include a disabled acceptance control 638 because party A gave access to party C as a third party negotiator. Similarly, party A, party B, or party C may grant access to other parties as negotiators and/or observers. The claim management system 106 may or may not disable an acceptance control 638 for the additional negotiators and/or observers depending on the level of access granted. Thus, one or more parties may be enabled to select the acceptance control 638 on behalf of the issuer or receiver.

It will be appreciated by those skilled in the art and others that all of the functions described in this disclosure may be embodied in software executed by one or more processors of the disclosed components and mobile communication devices. The software may be persistently stored in any type of non-volatile storage.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without party input or prompting, whether these features, elements and/or steps are included or are to be performed in any particular embodiment.

Any process descriptions, elements, or blocks in the flow diagrams described herein and/or depicted in the attached FIGURES should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer readable storing the computer executable components such as a CD-ROM, DVD-ROM, or network interface further, the component and/or data can be included in a single device or distributed in any manner. Accordingly, general purpose computing devices may be configured to implement the processes, algorithms and methodology of the present disclosure with the processing and/or execution of the various data and/or components described above.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method for automatically updating a status of a claim regarding a marine charter, the computer-implemented method comprising:
under the control of one or more computing devices:
tracking a history of offers made electronically between a first party and a second party, wherein the offers made relate to settlement of a claim regarding a marine charter;
enabling the first party and the second party to perform at least one of making an offer, uploading a document, and accepting an offer;
generating a user interface for use by at least one of the first party and the second party, the user interface comprising:
the tracked history of offers made electronically by the first party and the second party,
an acceptance control for selection of a last offer made electronically by at least one of the first party and the second party, and
an indicator that reflects a status of the claim;
automatically updating the indicator upon selection of the acceptance control by at least one of the first party and the second party; and
automatically generating a notification indicating that the last offer made electronically by the at least one of the first party and the second party has been accepted.

2. The computer-implemented method of claim 1, wherein at least one of the first party and the second party is a negotiating party acting on behalf of a contract party.

3. The computer-implemented method of claim 1, further comprising enabling a third party to perform on behalf of at least one of the first party and the second party at least one of making an offer, uploading a document, and selecting the acceptance control.

4. The computer-implemented method of claim 1, further comprising configuring the user interface based at least in part on what a party is enabled to perform.

5. A computer-implemented method for automatically updating a status of a claim regarding a contract, the computer-implemented method comprising:
under the control of one or more computing devices:
enabling a first party and a second party to perform at least one of making an offer, uploading a document, and accepting an offer;
tracking a history of offers made by at least one of a first party and a second party, wherein the offers made relate to settlement of a claim regarding a contract;
generating a user interface for displaying the history of offers made, the user interface comprising:
a last offer made electronically by or on behalf of a contracting party;
an acceptance control for selection of the last offer made; and
a status indicator for the claim that reflects a current status of the claim; and
automatically updating the status indicator of the user interface upon selection of the acceptance control.

6. The computer-implemented method of claim 5, wherein at least one of the first party and the second party is a negotiating party acting on behalf of a contract party.

7. The computer-implemented method of claim 5, further comprising automatically updating claim data and negotiation summary data associated with the claim upon selection of the acceptance control.

8. The computer-implemented method of claim 5, further comprising automatically generating a notification indicating that the last offer made electronically by or on behalf of the contracting party has been accepted.

9. The computer-implemented method of claim 5, further comprising receiving communication data to associate with the generated notification.

10. The computer-implemented method of claim 5, further comprising granting to at least one of the first party and the second party access to view the user interface.

11. The computer-implemented method of claim 5, further comprising granting to a third party access to view the user interface.

12. The computer-implemented method of claim 5, further comprising enabling a third party to perform on behalf of at least one of the first party and the second party at least one of making an offer, uploading a document, and selecting the acceptance control.

13. The computer-implemented method of claim 12, further comprising automatically generating a notification indicating the third party has been enabled to perform on behalf of at least one of the first party and the second party at least one of making an offer, uploading a document, and selecting the acceptance control.

14. The computer-implemented method of claim 5, wherein automatically updating the indicator comprises configuring the indicator from a first status to a second status.

15. The computer-implemented method of claim 14, wherein the first status is an under negotiation status and the second status is an agreed status.

16. The computer-implemented method of claim 5, further comprising:
receiving at least one of an uploaded document and an offer;
automatically generating a notification indicating the receipt of at least one of an uploaded document and an offer.

17. The computer-implemented method of claim 5, wherein the first party is an issuer of a claim and the second party is a receiver of a claim.

18. The computer-implemented method of claim 5, further comprising:
receiving the last offer made electronically from the first party; and
enabling the second party to select the acceptance control.

19. The computer-implemented method of claim 5, wherein the user interface is a first user interface, and further comprising:
generating a second user interface for displaying the history of offers made, the user interface comprising:
the last offer made electronically; and
the status indicator;
wherein the first user interface is generated for the first party and the second user interface is generated for the second party.

20. The computer-implemented method of claim 5, further comprising:
enabling a third party to perform on behalf of the first party at least one of submitting an offer, uploading a document, and accepting an offer; and
disabling the first party from performing at least one of submitting an offer, uploading a document, and accepting an offer.

21. The computer-implemented method of claim 5, further comprising configuring the user interface based at least in part on what a party is enabled to perform.

22. The computer-implemented method of claim 5, further comprising enabling a party to select the acceptance control based at least in part on what the party is enabled to perform.

23. A computer-readable, non-transitory storage medium, having computer-executable components for managing a claim regarding a contract, the computer-executable components comprising:
a tracking component for tracking a history of offers made between parties to the contract; and
a user interface component that:
enables a party to view the tracked history of offers made between the parties to the contract and to view a status indicator reflecting a current status of the claim;
enables the party to accept a last offer made between the parties to the contract from the tracked history by selecting an acceptance control; and
automatically updates the status indicator after acceptance of the last offer.

24. The computer-executable components of claim 23, wherein the party is a negotiating party acting on behalf of at least one of the parties to the contract.

25. The computer-executable components of claim 23, wherein the user interface component is further configured to automatically generate a notification indicating that the last offer made electronically between the parties to the contract has been accepted, upon selection of the acceptance control.

26. The computer-executable components of claim 23, wherein the user interface component receives the last offer made electronically from one of the parties to the contract and enables another party of the parties to the contract to select the acceptance control.

27. A system for automatically managing a claim regarding a contract, the system comprising:
a data storage device that stores electronically submitted offers made between at least two different parties, wherein the electronically submitted offers relate to settlement of a claim regarding a contract; and
a computing device in communication with the data storage device that operates to:
track the electronically submitted offers;
enable each of the at least two different parties to perform at least one of making an offer, uploading a document, and accepting an offer;
generate a display of the electronically submitted offers in an order in which the offers were submitted, wherein the display further includes:
a status indicator that reflects the status of the claim regarding the contract; and
an acceptance control associated with a last electronically submitted offer, wherein selection of the acceptance control indicates acceptance of the last electronically submitted offer by at least one of the two different parties; and
automatically update the status indicator to reflect the status of the claim upon selection of the acceptance control.

28. The system of claim 27, wherein at least one of the at least two different parties is a negotiating party acting on behalf of a contract party.

29. The system of claim 27, wherein the computing device further operates to enable a third party to perform on behalf of at least one of the at least two different parties at least one of making an offer, uploading a document, and selecting the acceptance control.

30. The system of claim 27, wherein the computing device further operates to configure the display based at least in part on what a party is enabled to perform.

31. A computer-implemented method for automatically updating a status of a claim related to a contract, the computer-implemented method comprising:
under the control of one or more computing devices:
tracking a history of offers made between at least two parties, wherein the offers made relate to a settlement of a claim between at least an issuer and a receiver; wherein the claim relates to a contract;
generating a user interface for use by at least one of the parties that comprises:
the tracked history of offers made between the at least two parties;
an acceptance control for selection by at least one of the parties of the last offer made; and
an indicator that reflects a status of the claim; and
automatically updating the indicator that reflects the status of the claim upon selection of the acceptance control, wherein
at least one of the at least two parties is a negotiating party acting on behalf of the issuer or the receiver.

32. The computer-implemented method of claim 31, further comprising automatically generating a notification indicating that the last offer made electronically has been accepted.
